(19) United States
(12) Patent Application Publication
(10) Pub. No.: US 2011/0063168 A1
(43) Pub. Date: Mar. 17, 2011

(54) PORTABLE ELECTRONIC DEVICE AND METHOD OF OPERATING THE SAME

(75) Inventor: Filip SKARP, Lund (SE)

(73) Assignee: Sony Ericsson Mobile Communications AB, Lund (SE)

(21) Appl. No.: 12/560,731

(22) Filed: Sep. 16, 2009

(51) Int. Cl. H01Q 3/00

(52) U.S. Cl. 342/359

(57) ABSTRACT

A portable electronic device is disclosed. The portable electronic device comprises an antenna with tunable directivity. Furthermore, the portable electronic device comprises an orientation unit adapted to sense an orientation of the portable electronic device. Moreover, the portable electronic device comprises a control unit operatively connected to the orientation unit and the antenna. The control unit is arranged to receive orientation data indicative of the orientation of the portable electronic device from the orientation unit, and to tune the directivity of the antenna based on the received orientation data. A method of operating the portable electronic device is also disclosed.

### TECHNICAL FIELD

The present invention relates to a portable electronic device having an antenna, and a method of operating the portable electronic device.

### BACKGROUND

Portable electronic devices, such as mobile telephones, are becoming increasingly more complex with an increasing degree of functionality being implemented therein. For example, recently developed mobile telephones are normally capable of communicating in a plurality of different communication networks, such as but not limited to GSM (Global System for Mobile communications) networks, UMTS (Universal Mobile Telecommunications System) networks, and/or WLAN (Wireless Local Area Network) networks. Furthermore, mobile telephones may comprise a short-range radio transceiver, such as a Bluetooth transceiver. Moreover, mobile telephones may comprise a satellite navigation unit, such as a GPS (Global Positioning System) navigation unit for determining the geographic location of the mobile telephone. For such a mobile telephone, there is a relatively large amount of antennas confined in a relatively small volume. This causes the antennas to load and adversely affect each other. This may degrade the performance of one or more transmitters and/or receivers of the mobile telephone. For example, inadequate performance of a GPS antenna may result in a poor positioning accuracy of a GPS navigation unit of the mobile telephone.

### SUMMARY

According to a first aspect, a portable electronic device is provided. The portable electronic device comprises an antenna with tunable directivity. Furthermore, the portable electronic device comprises an orientation unit adapted to sense an orientation of the portable electronic device. Moreover, the portable electronic device comprises a control unit operatively connected to the orientation unit and the antenna. The control unit is arranged to receive orientation data indicative of the orientation of the portable electronic device from the orientation unit. Furthermore, the control unit is adapted to tune the directivity of the antenna based on the received orientation data.

The orientation unit may be adapted to sense the orientation of the portable electronic device in relation to a gravitational field.

The orientation unit may comprise an accelerometer. The accelerometer may e.g. be a 3-axis DC-response accelerometer. Alternatively or additionally, the orientation unit may e.g comprise a MEMS (MicroElectroMechanical System) gyroscope or a mercury switch.

The portable electronic device may comprise a satellite navigation unit for detecting the location of the portable electronic device based on satellite navigation signals, and the antenna may adapted to receive the satellite navigation signals. The satellite navigation unit may be a global positioning system (GPS) navigation unit, and the antenna may be a GPS antenna.

The control unit may be adapted to tune the directivity of the antenna such that an angle between the direction of a gravitational force and a main direction of reception and/or radiation of the antenna is within a predetermined interval. The predetermined interval may e.g. be, but is not limited to 90° to 270° or 135° to 225°.

The directivity of the antenna may be tunable in discrete steps such that a main direction of reception and/or radiation of the antenna can be selected as one of a finite number of directions. The control unit may be adapted to tune the directivity of the antenna by selecting the one of said finite number of directions for which the angle between the direction of a gravitational force and said selected direction is closest to 180°.

The portable electronic device may e.g. be, but is not limited to a mobile telephone.

According to a second aspect, a method of operating a portable electronic device is provided. The portable electronic device comprises an antenna with tunable directivity, an orientation unit adapted to sense an orientation of the portable electronic device, and a control unit operatively connected to the orientation unit and the antenna. The method comprises receiving, in the control unit, orientation data indicative of the orientation of the portable electronic device from the orientation unit. Furthermore, the method comprises tuning, by the control unit, the directivity of the antenna based on the received orientation data.

The orientation of the portable electronic device may be an orientation in relation to a gravitational field. The orientation unit may comprise an accelerometer. The accelerometer may be a 3-axis DC-response accelerometer. Alternatively or additionally, the orientation unit may comprise a MEMS gyroscope or a mercury switch.

The portable electronic device may comprise a satellite navigation unit for detecting the location of the portable electronic device based on satellite navigation signals, and the antenna may be adapted to receive the satellite navigation signals. The satellite navigation unit may be a GPS navigation unit, and the antenna may be a GPS antenna.

Tuning the directivity of the antenna may comprise tuning the directivity such that an angle between the direction of a gravitational force and a main direction of reception and/or radiation of the antenna is within a predetermined interval. The predetermined interval may e.g. be, but is not limited to 90° to 270° or 135° to 225°.

The directivity of the antenna may be tunable in discrete steps such that a main direction of reception and/or radiation of the antenna can be selected as one of a finite number of directions. Tuning the directivity of the antenna may comprise selecting the one of said finite number of directions for which the angle between a gravitational force and said selected direction is closest to 180°.

According to a third aspect, there is provided a computer program product comprising computer program code for executing the method according to the second aspect when said computer program code is run by a programmable hardware unit of the control unit.

According to a fourth aspect, there is provided a computer readable medium having stored thereon a computer program product comprising computer program code for executing the method according to the second aspect when said computer program code is run by a programmable hardware unit of the control unit.

Further embodiments of the invention are defined in the dependent claims.

It should be emphasized that the term “comprises/comprising” when used in this specification is taken to specify the presence of stated features, integers, steps, or components, but does not preclude the presence or addition of one or more other features, integers, steps, components, or groups thereof.

### BRIEF DESCRIPTION OF THE DRAWINGS

Further objects, features and advantages of embodiments of the invention will appear from the following detailed description, reference being made to the accompanying drawings, in which:

FIG. 1 schematically illustrates an example environment wherein embodiments of the present invention may be utilized;

FIGS. 2a and b schematically illustrate radiation patterns of different antennas;

FIG. 3 is a block diagram of a portable electronic device according to an embodiment of the present invention;

FIGS. 4a and b illustrate different angle intervals according to embodiments of the present invention;

FIG. 5 is a flowchart of a method according to an embodiment of the present invention; and

FIG. 6 schematically illustrates a computer readable medium and a control unit comprising a programmable hardware unit according to an embodiment of the present invention.

### DETAILED DESCRIPTION

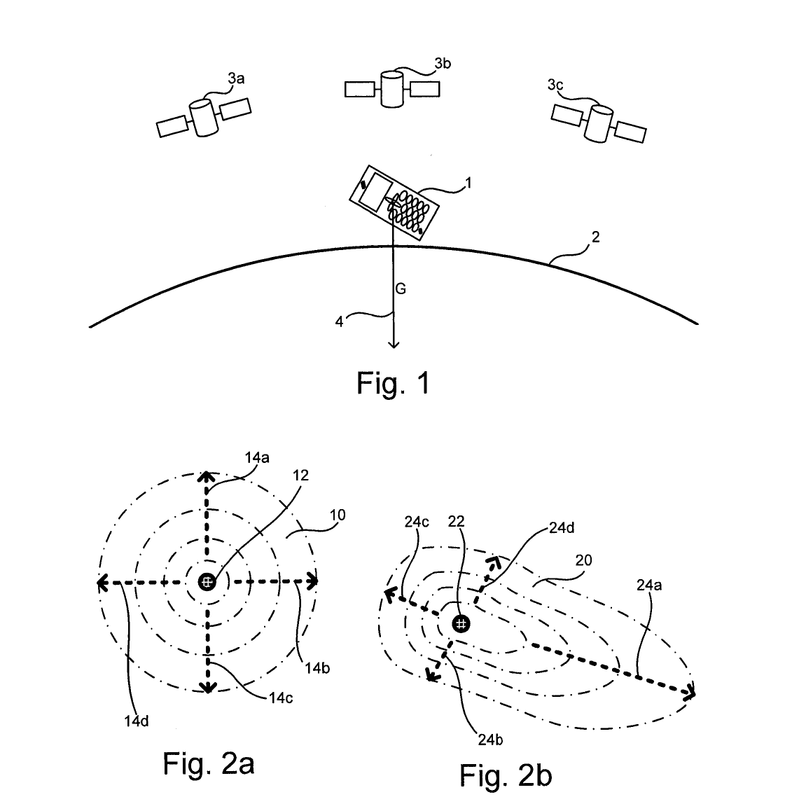

FIG. 1 (not drawn to scale) illustrates schematically an example environment wherein embodiments of the present invention may be utilized. A portable electronic device 1, illustrated in FIG. 1 as a mobile telephone, is located in proximity of the surface of the earth 2. For example, the portable electronic device 1 may be held in the hand of a user (not shown) of the portable electronic device 1, or be placed in a holder (not shown) for the portable electronic device 1 mounted on a dashboard in a vehicle (not shown), such as a passenger car or the like, etc. In this example, the portable electronic device 1 comprises a satellite navigation unit, such as a GPS (Global Positioning System) navigation unit for detecting the geographical location of the portable electronic device. Furthermore, a plurality of navigation satellites 3a-c, such as GPS satellites, are orbiting the earth in detection range of the portable electronic device 1. The direction 4 of a gravitational force G acting on the portable electronic device 1 is indicated in FIG. 1 as well.

FIG. 2a schematically illustrates the radiation pattern 12 of an ideal, or isotropic, antenna 12. As illustrated in FIG. 2a, the isotropic antenna 12 radiates equally in all directions, such as the directions 14a-14d indicated in FIG. 2a. If the antenna is used for reception, this translates to that the isotropic antenna receives signals equally well from all directions.

For a real (nonideal) antenna actually used in a portable electronic device, the radiation pattern can normally not be described as homogenous or equal. This is schematically illustrated in FIG. 2b, showing the radiation pattern 20 of a nonideal antenna 22. For the nonideal antenna 22, the radiation is stronger in a direction 24a than in the other directions, such as the directions 24b-d indicated in FIG. 2b. If the antenna is used for reception, this translates to that the nonideal antenna 22 has a better ability to receive (or stronger reception of) signals from the direction 24a than from the other directions. This property of the nonideal antenna 22 is normally referred to as directivity. The radiation pattern is determined by several factors such as the antenna layout, ground plane structure, and antenna matching, etc. In the following, the direction for a nonideal antenna in which the radiation/reception of the antenna is the strongest (i.e. direction 24a in FIG. 2b) is referred to as the main direction of radiation/reception of the antenna.

For simplicity of illustration, the radiation patterns 10 and 20 in FIGS. 2a and b are shown in two dimensions, even though the antennas 12 and 22 actually radiate in three dimensions. The radiation patterns 10 and 20 illustrated in FIGS. 2a and b can be seen as cross-sectional views of the actual three-dimensional radiation patterns.

Again with reference to FIG. 1, a preferred main direction of reception of a satellite navigation antenna, connected to the satellite navigation unit of the portable electronic device, is a direction to a region where satellites 3a-c in range of the portable electronic device 1 are located, i.e. “towards the sky” or (essentially) up (the direction 4 being down). However, relative to the portable electronic device 1, this preferred main direction of reception depends on the orientation of the portable electronic device 1. An antenna designed for optimum directivity in one orientation of the portable electronic device 1 may give worse performance if the portable electronic device 1 is oriented in another orientation, e.g. in this example if the portable electronic device 1 is oriented such that the main direction of reception is directed towards the earth rather than towards the sky.

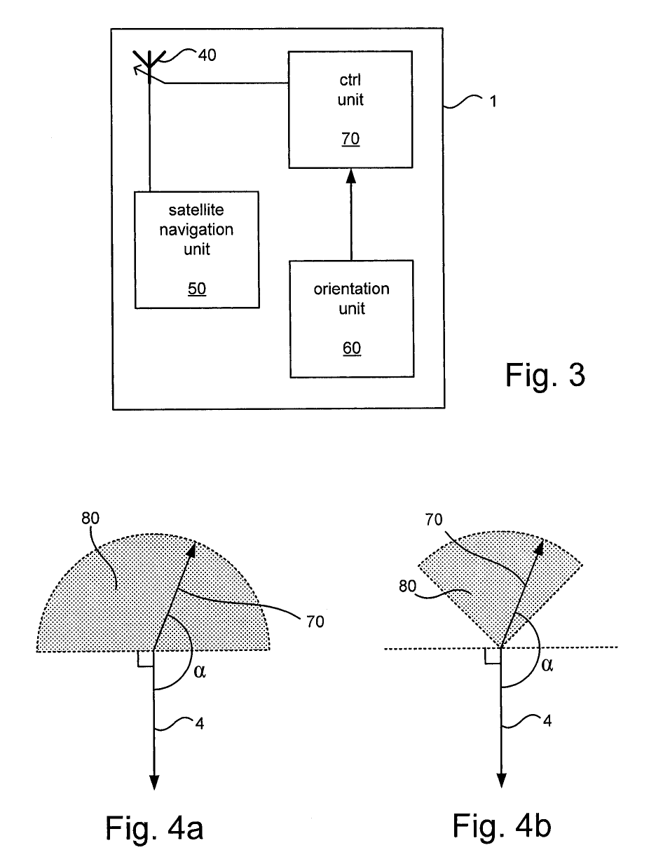

FIG. 3 is a block diagram of the portable electronic device 1 according to an embodiment of the present invention. According to the embodiment, the portable electronic device 1 comprises an antenna 40 with tunable directivity. For example, the antenna 40 may be implemented with a plurality, such as but not limited to four, matches or antenna elements (not shown), that are optimized for reception in different directions (relative to the portable electronic device 1). The directivity of the antenna 40 may then be tuned by selecting a particular one of the matches to use. The tunability of the directivity can be increased by introducing more matches or antenna elements and/or using matches or antenna elements that are themselves tunable. Hence, the directivity of the antenna 40 may be tunable in discrete steps or continuously. Implementation of such tunable antennas is known and is not further described herein.

Furthermore, as illustrated with the embodiment in FIG. 3, the portable electronic device 1 may comprise a satellite navigation unit 50, such as a GPS navigation unit, for detecting the geographical location of the portable electronic device 1 based on satellite navigation signals, e.g. from the satellites 3a-c (FIG. 1). The antenna 40 may thus be adapted to receive the satellite navigation signals. For example, the antenna 40 may be a GPS antenna.

Moreover, in the embodiment illustrated in FIG. 3, the portable electronic device 1 comprises an orientation unit 60 adapted to sense an orientation of the portable electronic device 1. In addition, the portable electronic device 1 comprises a control unit 70 operatively connected to the orientation unit 60 and the antenna 40. The control unit 70 is arranged to receive orientation data indicative of the orientation of the portable electronic device 1 from the orientation unit 60. Furthermore, the control unit 70 is arranged to tune the directivity of the antenna 40 based on the received orientation data.

The orientation unit 70 may be adapted to sense the orientation of the portable electronic device 1 in relation to a gravitational field, e.g. in relation to the direction 4 illustrated in FIG. 1. For example, the orientation unit 50 may comprise an accelerometer, such as a 3-axis DC-response accelerometer (not shown). Such an accelerometer may be used to detect an inclination of the portable electronic device 1 relative to the direction 4 of the gravitational force G (FIG. 1). Hence, the orientation to be sensed by the orientation unit 60 may be an inclination of the portable electronic device 1 relative to the direction 4 of the gravitational force G. Furthermore, in some available portable electronic devices, such as some mobile telephones, such accelerometers are already included for other purposes. Hence, the overhead cost and/or overhead complexity for the inclusion of the orientation unit 60 may be relatively low.

Alternatively or additionally, the orientation unit 50 may comprise a MEMS (MicroElectroMechanical System) gyroscope (not shown) or one or more mercury switches (not shown) for sensing the orientation of the portable electronic device 1.

According to some embodiments of the present invention, the control unit 70 may be adapted to tune the directivity of the antenna 40 such that an angle α between the direction 4 of the gravitational force 4 and the main direction of reception of the antenna 40 is within a certain interval. Said interval may e.g. be a predetermined interval. For example, the interval may be chosen such that the main direction of reception of the antenna 40 is pointing “towards the sky”, or essentially upwards. According to some embodiments, said interval is between 90° and 270°. This is illustrated in FIG. 4a, where the main direction of reception of the antenna 40 is labelled with the reference sign 70. Furthermore, the allowable interval of the angle α is indicated with a shaded area 80 in FIG. 4a. According to other embodiments, other intervals may be used. Such another interval may e.g. be a subinterval of 90° to 270°. This is illustrated in FIG. 4b, using the corresponding notation as in FIG. 4a. According to some embodiments, the interval is between 135° and 225°. According to some embodiments, the directivity of the antenna 40 is tunable in discrete steps such that a main direction of reception of the antenna 40 can be selected as one of a finite number of directions. In these embodiments, the control unit 70 may be adapted to tune the directivity of the antenna 40 by selecting the one of said finite number of directions for which the angle between the direction 4 of the gravitational force G and the selected direction is closest to 180°. This corresponds to the one of the directions that points “most upwards”.

With the satellite navigation examples described with reference to FIG. 3 and FIG. 4a-b above, it is made sure that the antenna 40 is always listening essentially upwards regardless of the orientation of the portable electronic device 1. Thereby, an improved positioning accuracy of the satellite navigation unit 50 can be achieved.

Embodiments of the present invention have been described in the context of satellite navigation, such as GPS navigation. However, in other embodiments, tuning of the directivity of an antenna based on the orientation of the electronic device 1 may be employed in other applications as well where such tuning would be beneficial. For example, the portable electronic device 1 may be a satellite telephone, and the antenna may be a transmit and/or receive antenna for transmitting and/or receiving signals to/from communication satellites. In such a scenario, the tuning of the antenna enables an improved signal quality for transmitted and/or received signals. Furthermore, in the satellite navigation examples above, the directivity of the antenna 40 is tuned by tuning a main direction of reception. In a more general sense, which also takes into account the cases where the antenna is additionally or alternatively used for transmitting signals, the antenna 40 may be tuned by tuning a main direction of reception and/or radiation of the antenna 40.

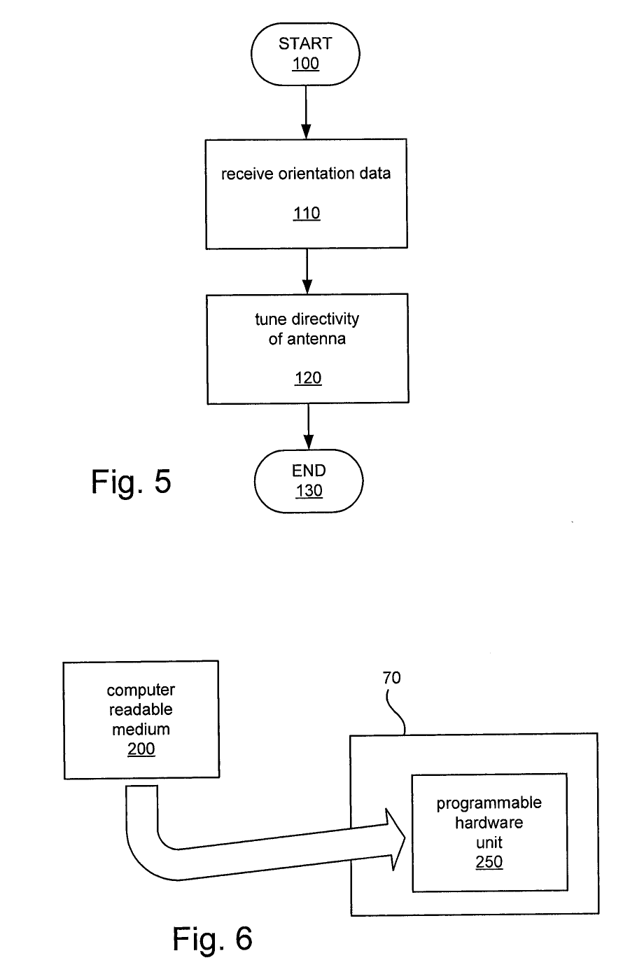

According to some embodiments of the present invention, there is provided a method of operating the portable electronic device 1. The method comprises receiving, in the control unit 70, the above-mentioned orientation data indicative of the orientation of the portable electronic device 1 from the orientation unit 60. Furthermore, the method comprises tuning, by the control unit 70, the directivity of the antenna 40 based on the received orientation data, e.g. as has been described with reference to any of the embodiments of the portable electronic device 1 above. An embodiment of the method is illustrated in FIG. 5. In step 100, the operation of the method is started. Furthermore, in step 110, the orientation data is received. Moreover, in step 120, the directivity of the antenna 40 is tuned. The operation of the method is ended in step 130. The steps illustrated in FIG. 5 may be iterated as necessary, e.g. with regular intervals.

Tuning the directivity of the antenna 40 may comprise tuning the directivity of the antenna 40 such that an angle α between the direction 4 of the gravitational force 4 and the main direction of reception of the antenna 40 is within a certain interval, e.g. in accordance with what is described above with reference to embodiments of the portable electronic device 1.

The control unit 70 (FIG. 3) may be implemented as an application-specific hardware unit. Alternatively, the control unit 70 or parts thereof may be implemented using one or more configurable or programmable hardware units, such as but not limited to one or more field-programmable gate arrays (FPGAs), processors, or microcontrollers. Hence, embodiments of the present invention may be embedded in a computer program product, which enables implementation of the method and functions described herein, e.g. the embodiments of the method described with reference to FIG. 5. Therefore, according to embodiments of the present invention, there is provided a computer program product, comprising instructions arranged to cause a programmable hardware unit (e.g. programmable hardware unit 250 in FIG. 6) of the control unit 70, such as the aforementioned one or more processors or micro controllers, to perform the steps of any of the embodiments of the method described herein. The computer program product may comprise program code which is stored on a computer readable medium 200, as illustrated in FIG. 6, which can be loaded and executed by the programmable hardware unit 250, to cause it to perform the steps of any of the embodiments of the method described herein.

The present invention has been described above with reference to specific embodiments. However, other embodiments than the above described are possible within the scope of the invention. Different method steps than those described above, performing the method by hardware or software, may be provided within the scope of the invention. The different features and steps of the embodiments may be combined in other combinations than those described. The scope of the invention is only limited by the appended patent claims.

1. A portable electronic device comprising:
an antenna with tunable directivity;
an orientation unit adapted to sense an orientation of the portable electronic device; and
a control unit operatively connected to the orientation unit and the antenna, wherein the control unit is arranged to receive orientation data indicative of the orientation of the portable electronic device from the orientation unit, and to tune the directivity of the antenna based on the received orientation data.

2. The portable electronic device according to claim 1, wherein the orientation unit is adapted to sense the orientation of the portable electronic device in relation to a gravitational field.

3. The portable electronic device according to claim 2, wherein the orientation unit comprises an accelerometer.

4. The portable electronic device according to claim 3, wherein the accelerometer is a 3-axis DC-response accelerometer.

5. The portable electronic device according to claim 2, wherein the orientation unit comprises a microelectromechanical system, MEMS, gyroscope or a mercury switch.

6. The portable electronic device according to claim 2, comprising a satellite navigation unit for detecting the location of the portable electronic device based on satellite navigation signals, wherein the antenna is adapted to receive the satellite navigation signals.

7. The portable electronic device according to claim 6, wherein the satellite navigation unit is a global positioning system, GPS, navigation unit, and the antenna is a GPS antenna.

8. The portable electronic device according to claim 1, wherein the control unit is adapted to tune the directivity of the antenna such that an angle between the direction of a gravitational force and a main direction of reception and/or radiation of the antenna is within a predetermined interval.

9. The portable electronic device according to claim 8, wherein the predetermined interval is 90° to 270°.

10. The portable electronic device according to claim 8, wherein the predetermined interval is 135° to 225°.

11. The portable electronic device according to claim 2, wherein the directivity of the antenna is tunable in discrete steps such that a main direction of reception and/or radiation of the antenna can be selected as one of a finite number of directions, and the control unit is adapted to tune the directivity of the antenna by selecting the one of said finite number of directions for which the angle between the direction of a gravitational force and said selected direction is closest to 180°.

12. The portable electronic device according to claim 1, wherein the portable electronic device is a mobile telephone.

13. A method of operating a portable electronic device comprising:
an antenna with tunable directivity;
an orientation unit adapted to sense an orientation of the portable electronic device; and
a control unit operatively connected to the orientation unit and the antenna;
wherein the method comprises:
receiving, in the control unit, orientation data indicative of the orientation of the portable electronic device from the orientation unit; and
tuning, by the control unit, the directivity of the antenna based on the received orientation data.

14. The method according to claim 13, wherein the orientation of the portable electronic device is an orientation in relation to a gravitational field.

15. The method according to claim 14, wherein the orientation unit comprises an accelerometer.

16. The method according to claim 15, wherein the accelerometer is a 3-axis DC-response accelerometer.

17. The method according to claim 14, wherein the orientation unit comprises a microelectromechanical system, MEMS, gyroscope or a mercury switch.

18. The method according to claim 13, wherein the portable electronic device comprises a satellite navigation unit for detecting the location of the portable electronic device based on satellite navigation signals, and the antenna is adapted to receive the satellite navigation signals.

19. The method according to claim 18, wherein the satellite navigation unit is a global positioning system, GPS, navigation unit, and the antenna is a GPS antenna.

20. The method according to claim 14, wherein tuning the directivity of the antenna comprises tuning the directivity such that an angle between the direction of a gravitational force and a main direction of reception and/or radiation of the antenna is within a predetermined interval.

21. The method according to claim 20, wherein the predetermined interval is 90° to 270°.

22. The method according to claim 20, wherein the predetermined interval is 135° to 225°.

23. The method according to claim 14, wherein the directivity of the antenna is tunable in discrete steps such that a main direction of reception and/or radiation of the antenna can be selected as one of a finite number of directions, and tuning the directivity of the antenna comprises selecting the one of said finite number of directions for which the angle between a gravitational force and said selected direction is closest to 180°.

24. A computer program product comprising computer program code for executing the method according to any claim 13 when said computer program code is run by a programmable hardware unit of the control unit.

25. A computer readable medium having stored thereon a computer program product comprising computer program code for executing the method according to claim 13 when said computer program code is run by a programmable hardware unit of the control unit.
